(19) United States
(12) Patent Application Publication
(10) Pub. No.: US 2008/0133919 A1
(43) Pub. Date: Jun. 5, 2008

(54) METHOD AND APPARATUS FOR PERFORMING AUTHENTICATION

(75) Inventors: Yong-kuk YOU, Seoul (KR); Jun-bum SHIN, Suwon-si (KR); Seong-soo KIM, Seoul (KR); Su-hyun NAM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/945,601

(22) Filed: Nov. 27, 2007

Related U.S. Application Data
(60) Provisional application No. 60/872,502, filed on Dec. 4, 2006.

(30) Foreign Application Priority Data
Apr. 10, 2007 (KR) 10-2007-0035174

(51) Int. Cl. H04L 9/32

(52) U.S. Cl. 713/175

(57) ABSTRACT

A method and apparatus for performing authentication are provided. The method includes: receiving an authentication request signal for requesting authentication from an external device; determining whether authentication has been performed with the external device that has transmitted the authentication request signal; based on the determination, selectively outputting an indication representing that it is necessary to perform authentication with the external device; if the indication representing that it is necessary to perform authentication with the external device is output, receiving an authentication execution command for instructing the execution of authentication in response to the indication; and performing authentication with the external device according to the authentication execution command.

### CROSS-REFERENCE TO RELATED PATENT APPLICATIONS

This application claims the benefits of U.S. Provisional Application No. 60/872,502, filed on Dec. 4, 2006, in the U.S. Patent and Trademark Office, and Korean Patent Application No. 10-2007-0035174, filed on Apr. 10, 2007, in the Korean Intellectual Property Office, the disclosures of which are incorporated herein in their entirety by reference.

### BACKGROUND OF THE INVENTION

1. Field of the Invention

The present invention relates to a method and apparatus for performing authentication.

2. Description of the Related Art

Research into transmitting and receiving content between audio/video devices and sharing of the content in a home network has been recently conducted. Protection of the content being transmitted and received is highly important.

In particular, there are more considerations in a wireless connection of devices than a wired connection thereof. In the wired connection, a user connects his devices using a wired cable thereby making the authentication between devices easier. However, in the wireless connection, since there is no physical connection means, it is necessary to find a substitute method for authentication.

For example, according to digital transmission content protection (DTCP) of DTLA (http://www.dtcp.com) that is a representative content protection technology of wired data transmission and reception used by IEEE 1394, authentication key exchange (AKE), which is a DTCP authentication process, determines whether a counterpart device is authentic or not; however, it cannot verify whether the counterpart device is a device next door or an attacker's device. Thus, an additional operation of limiting devices at home is needed in order to use the DTCP to transmit and receive data in wireless.

Actually, when a DTCP over Internet protocol (DTCP-IP) is applied to an 802.11 wireless LAN environment, wired equivalent privacy (WEP), which is a privacy protection protocol defined in the 802.11 standard, or a corresponding protection technology (e.g., Wi-Fi protected access (WPA) or WPA2) is used before DTCP authenticated or protected content is transmitted.

FIG. 1 illustrates a conventional method of authenticating devices. Referring to FIG. 1, an access point (AP) 110 and a client 120 share a common secret key using WEP, and transmit/receive encrypted data using the common secret key.

By using the WEP, the AP 110 and the client 120 share the common secret key to transmit/receive encrypted data therebetween. A user generally establishes the common secret key by inputting a password or an identification number of the AP 110 with his hand, which causes the user inconvenience. In particular, it is very difficult to input the common secret key into customer electronics (CE) devices.

### SUMMARY OF EXEMPLARY EMBODIMENTS OF THE INVENTION

Exemplary embodiments of the present invention provide a method and apparatus for performing authentication by which a user can easily authenticate devices at home in wireless.

According to an aspect of the present invention, there is provided a method of performing authentication comprising: receiving an authentication request signal for requesting authentication from an external device; determining whether authentication has been performed with the external device that has transmitted the authentication request signal; based on the determination, selectively outputting an indication representing that it is necessary to perform authentication with the external device; if the indication representing that it is necessary to perform authentication with the external device is output, receiving an authentication execution command for instructing the execution of authentication in response to the indication; and performing authentication with the external device according to the authentication execution command.

The method may further comprise: if authentication is completely performed with the external device, registering the external device that has performed authentication with an authentication list that is a list of devices that have performed authentication.

The registering of the external device may comprise: registering at least one of an ID of the external device that has performed authentication and an authentication key shared with the external device that has performed authentication with the authentication list.

The registering of the external device may further comprise: if the number of external devices registered in the authentication list exceeds the maximum number of authenticated devices, deleting one of the devices registered in the authentication list and registering the external device that has performed authentication with the authentication list.

The registering of the external device may further comprise: deleting a least frequently used device from the devices registered in the authentication list and registering the external device that has performed authentication with the authentication list.

The determining of whether authentication has been performed may comprise: determining that authentication has been performed according to whether the external device that has transmitted the authentication request signal is registered with the authentication list that is a list of devices having performed authentication.

The determining of whether authentication has been performed may further comprise: determining that authentication has been performed according to whether at least one of an ID of the external device that has transmitted the authentication request signal and an authentication key shared by the external device that has transmitted the authentication request signal is stored in the authentication list.

The selectively outputting of the indication may comprise: if it is determined that authentication has not been performed with the external device, outputting the indication representing that it is necessary to perform authentication with the external device.

The method may further comprise: if it is determined that authentication has been performed with the external device, determining whether the external device has the authentication key, the indication representing that it is necessary to perform authentication with the external device is selectively output depending on whether the external device has the authentication key.

The selectively outputting of the indication may further comprise: if it is determined that the external device does not have the authentication key, outputting the indication representing that it is necessary to perform authentication with the external device.

The selectively outputting of the indication may further comprise: outputting a predetermined sentence indicating that it is necessary to perform authentication with the external device.

The selectively outputting of the indication may further comprise: outputting a light generated by flickering a screen for a predetermined period of time.

The receiving of the authentication request signal may comprise: further receiving a certificate of the external device that has transmitted the authentication request signal.

The method may further comprise: determining whether the certificate is valid and revoked or not, based on the determination of whether the certificate is valid and revoked or not, it is selectively determined whether the external device has performed authentication.

It may be determined whether the external device has performed authentication only if it is determined that the certificate is valid and is not revoked.

The performing of the authentication may comprise: generating a random number; and encrypting the random number using a public key of the external device that has transmitted the authentication request signal included in the certificate, and transmitting the encrypted random number to the external device.

The performing of the authentication may further comprise: generating the authentication key according to an authentication key exchange (AKE) of digital transmission content protection (DTCP).

The receiving of the authentication request signal may further comprise: if a plurality of authentication request signals are received, selecting one of a plurality of external devices that have transmitted the plurality of authentication request signals to perform authentication, determining of whether the external device has performed authentication based on the determination of whether the selected external device has performed authentication.

According to another aspect of the present invention, there is provided an apparatus for performing authentication comprising: a receiving unit receiving an authentication request signal for requesting authentication from an external device; an authentication determining unit determining whether authentication has been performed with the external device that has transmitted the authentication request signal; an outputting unit selectively outputting an indication representing that it is necessary to perform authentication with the external device based on the determination made by the authentication determining unit; if the receiving unit receives an authentication execution command for instructing the execution of authentication in response to the indication output by the outputting unit, an authenticating unit performing authentication with the external device according to the authentication execution command.

The apparatus may further comprise: an authentication list registering unit, if the authenticating unit completely performs authentication with the external device, registering the external device that has performed authentication with an authentication list that is a list of devices that have performed authentication.

The apparatus may further comprise: if the authentication determining unit determines that authentication has been performed with the external device, an authentication key determining unit determining whether the external device has the authentication key, the outputting unit selectively outputs the indication representing that it is necessary to perform authentication with the external device depending on whether the external device has the authentication key.

The apparatus may further comprise: a certificate determining unit which determines whether the certificate is valid and revoked or not, wherein the authentication determining unit, based on the determination made by the certificate determining unit, selectively determines whether authentication has been performed with the external device that has transmitted the authentication request signal.

The authenticating unit may comprise: a random number generating unit generating a random number; an encrypting unit encrypting the random number using a public key of the external device that has transmitted the authentication request signal included in the certificate; and a transmitting unit transmitting the encrypted random number to the external device that has transmitted the authentication request signal included in the certificate.

The encrypting unit may encrypt an intrinsic identification number of the apparatus for performing authentication using the public key of the external device that has transmitted the authentication request signal included in the certificate, the transmitting unit transmits the encrypted intrinsic identification number to the external device that has transmitted the authentication request signal.

The apparatus may further comprise: a device selecting unit, if the receiving unit receives a plurality of authentication request signals, selecting one of a plurality of external devices that have transmitted the plurality of authentication request signals to perform authentication, the authentication determining unit determines whether the external device selected by the device selecting unit has performed authentication.

The apparatus may further comprise: an input device transmitting the authentication execution command to the receiving unit.

The input device, if the receiving unit receives the plurality of authentication request signals, may transmit a signal for selecting an external device performing authentication from the plurality of external devices that have transmitted the authentication request signals to the receiving unit, the authentication determining unit may determine whether the external device selected by the signal transmitted from the input device has performed authentication.

According to another aspect of the present invention, there is provided a computer readable medium having recorded thereon a program for executing a method of performing authentication comprising: receiving an authentication request signal for requesting authentication from an external device; determining whether authentication has been performed with the external device that has transmitted the authentication request signal; based on the determination, selectively outputting an indication representing that it is necessary to perform authentication with the external device; if the indication representing that it is necessary to perform authentication with the external device is output, receiving an authentication execution command for instructing the execution of authentication in response to the indication; and performing authentication with the external device according to the authentication execution command.

### BRIEF DESCRIPTION OF THE DRAWINGS

The above and other features of the present invention will become more apparent by describing in detail exemplary embodiments thereof with reference to the attached drawings in which:

FIG. 1 illustrates a conventional method of authenticating devices;

FIG. 2 is a block diagram of an apparatus for performing authentication, according to an exemplary embodiment of the present invention;

FIG. 3 is a block diagram of an authenticating unit, according to an exemplary embodiment of the present invention; and

FIG. 4 is a flowchart illustrating a method of performing authentication, according to an exemplary embodiment of the present invention.

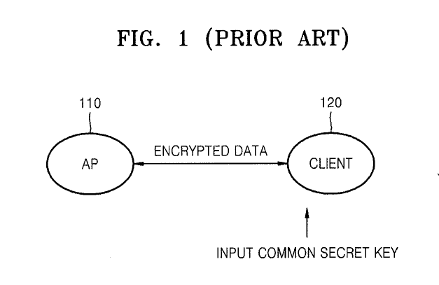

### DETAILED DESCRIPTION OF EXEMPLARY EMBODIMENTS OF THE INVENTION

The present invention will now be described more fully with reference to the accompanying drawings, in which exemplary embodiments of the invention are shown.

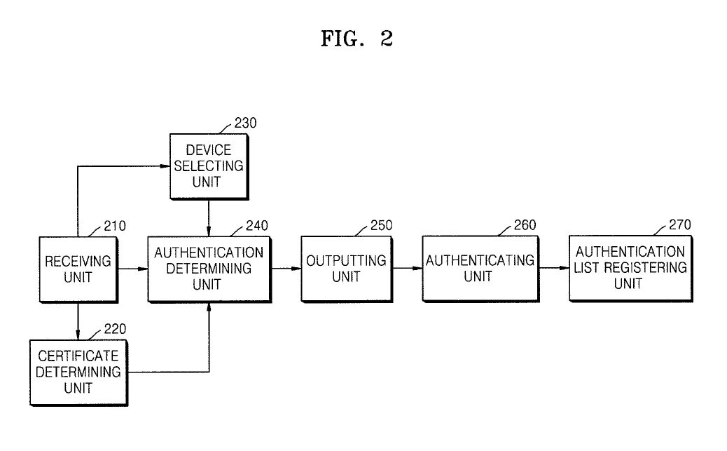

FIG. 2 is a block diagram of an apparatus for performing authentication, according to an exemplary embodiment of the present invention. Referring to FIG. 2, the apparatus includes a receiving unit 210, a certificate determining unit 220, a device selecting unit 230, an authentication determining unit 240, an outputting unit 250, an authenticating unit 260, and an authentication list registering unit 270. The apparatus may not include the certificate determining unit 220, the device selecting unit 230, and the certificate list registering unit 270 according to an exemplary embodiment of the present invention.

The receiving unit 210 receives an authentication request signal. The receiving unit 210 can receive a certificate of an external device that has transmitted the authentication request signal. The certificate of the external device may comprise an ID of the external device, a public key of the external device, and data that is encrypted hash values of the ID and the public key of the external device using a secret key of a certificate authority.

The external device may transmit the authentication request signal to perform initial authentication with the apparatus for performing authentication, or perform authentication necessary for accessing content included in the apparatus for performing authentication.

The certificate determining unit 220 determines whether the certificate is valid and revoked or not. Based on the determination made by the certificate determining unit 220, only if it is determined that the certificate is valid and is not revoked, the operation of the authentication determining unit 240 will proceed later.

If the receiving unit 210 receives a plurality of authentication request signals, the device selecting unit 230 selects one of a plurality of external devices that transmit the plurality of authentication request signals to perform authentication.

In more detail, if devices A, B, and C all transmit authentication request signals to the apparatus for performing authentication, the device selecting unit 230 selects one of the devices A, B, and C to perform authentication.

For example, the device selecting unit 230 can search for the external devices that transmit the authentication request signals, display the found external devices on a screen, and select one of the displayed external devices to perform authentication.

The apparatus for performing authentication may further comprise an input device (not shown) that transmits a signal for selecting an external device performing authentication from the external devices that transmit the authentication request signals to the receiving unit 210.

For example, if all the devices A, B, and C transmit the authentication request signals to the apparatus for performing authentication, a user can transmit a signal for instructing the apparatus for performing authentication and the device A to perform authentication, using the input device such as a remote controller.

The authentication determining unit 240 determines whether the apparatus for performing authentication has performed authentication with the external device that has transmitted the authentication request signal received by the receiving unit 210.

In more detail, the authentication determining unit 240 determines whether the apparatus for performing authentication has performed authentication with the external device that has transmitted the authentication request signal according to whether the external device that has transmitted the authentication request signal is registered with an authentication list which is a list of devices having performed authentication.

For example, the authentication determining unit 240 can determine whether the apparatus for performing authentication has performed authentication with the external device that has transmitted the authentication request signal if at least one of an ID of the external device that has transmitted the authentication request signal and an authentication key shared by the apparatus for performing authentication and the external device that has transmitted the authentication request signal is registered with the authentication list.

Based on the determination made by the authentication determining unit 240, if it is determined that the apparatus for performing authentication has performed authentication with the external device that has transmitted the authentication request signal, the apparatus for performing authentication can further comprise an authentication key determining unit (not shown) that determines whether the external device has the authentication key.

The authentication key determining unit can determine whether the external device that has transmitted the authentication request signal has the authentication key through the following process.

The authentication key determining unit generates a predetermined random number N_{c}, encrypts the random number N_{c} using the authentication key K_{AUTH} shared by the apparatus for performing authentication and the external device that has transmitted the authentication request signal, and transmits the encrypted random number to the external device.

The external device decrypts the encrypted random number N_{c} and transmits the decrypted random number to the apparatus for performing authentication. The apparatus for performing authentication determines whether the decrypted random number is identical to the encrypted random number. If it is determined that both random numbers are identical to each other, the authentication key determining unit determines that the external device has the authentication key.

According to another exemplary embodiment, the authentication key determining unit transmits the random number N_{c} to the external device, receives a value obtained by encrypting the random number N_{c} using the authentication key K_{AUTH} from the external device, decrypts the value, and verifies the random number N_{c} to determine whether the external device has the authentication key.

In this way, if the authentication key determining unit determines that the external device has the authentication key, it is not necessary to perform authentication with the external device, and vice versa. Therefore, if the authentication key determining unit determines that the external device does not have the authentication key, the outputting unit 250 selectively outputs an indication representing that it is necessary to perform authentication with the external device.

The outputting unit 250 selectively outputs the indication representing that it is necessary to perform authentication with the external device based on the determination made by the authentication determining unit 240.

In more detail, if the authentication determining unit 240 determines that the apparatus for performing authentication has not performed authentication with the external device or that the apparatus for performing authentication has performed authentication with the external device while the external device does not have the authentication key, the outputting unit 250 outputs the indication representing that it is necessary to perform authentication with the external device.

The outputting unit 250 can output a predetermined sentence representing that it is necessary to perform authentication with the external device or a light generated by flickering the screen for a predetermined period of time.

For example, the outputting unit can output a sentence “authentication is required” or the light generated by flickering the screen for 10 seconds.

The outputting unit 250 may further comprise a light emitting means for generating the light.

If the receiving unit 210 receives an authentication execution command in response to the indication output by the outputting unit 250, the authenticating unit 260 performs authentication with the external device according to the authentication execution command.

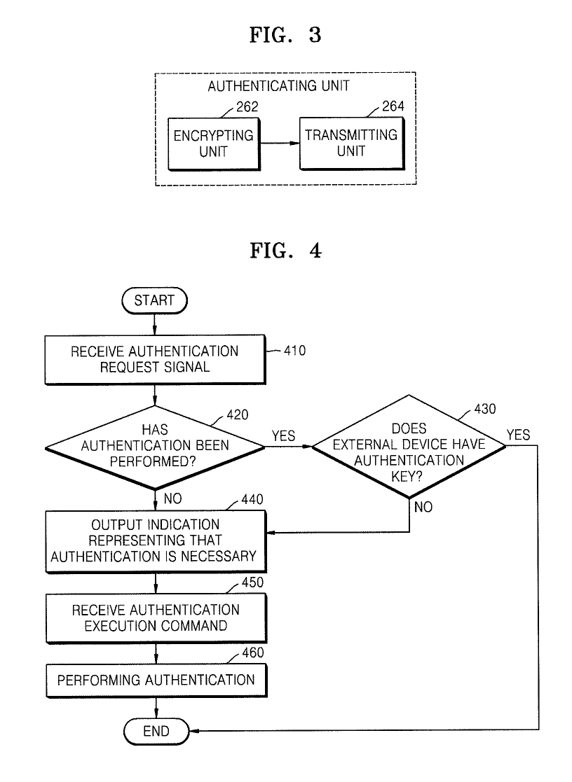

FIG. 3 is a block diagram of the authenticating unit 260, according to an exemplary embodiment of the present invention. Referring to FIG. 3, the authenticating unit 260 comprises an encrypting unit 262 and a transmitting unit 264.

The encrypting unit 262 encrypts an intrinsic identification number of the apparatus for performing authentication of the present embodiment using a public key of the external device that has transmitted the authentication request signal included in the certificate of the external device received by the receiving unit 210.

The transmitting unit 264 transmits the encrypted intrinsic identification number of the apparatus for performing authentication to the external device that has transmitted the authentication request signal.

The external device decrypts the encrypted intrinsic identification number of the apparatus for performing authentication, extracts the intrinsic identification number, and determines the extracted intrinsic identification number as an authentication key in order to use the authentication key to transmit/receive encrypted data to/from the apparatus for performing authentication of the present embodiment. Or a separate encryption key used to encrypt data can be generated using the authentication key.

According to another exemplary embodiment, the authenticating unit 260 can further comprise a random number generating unit (not shown) for generating the authentication key.

In more detail, if the random number generating unit generates a random number, the encrypting unit 262 encrypts the random number using the public key of the external device that has transmitted the authentication request signal, and the transmitting unit 264 transmits the encrypted random number to the external device that has transmitted the authentication request signal.

The apparatus for performing authentication and the external device generate the encryption key for encrypting data using the random number and transmit/receive the encrypted data using the encryption key.

According to another exemplary embodiment, the authenticating unit 260 can generate the authentication key according to an authentication key exchange (AKE) of digital transmission content protection (DTCP).

The authentication execution command is given by the user who examines the indication output by the outputting unit 250 representing that it is necessary to perform authentication.

The user can transmit the authentication execution command to the receiving unit 210 through a remote inputting device such as the remote controller.

The apparatus for performing authentication may further comprise an input device (not shown) for sending the authentication execution command to the receiving unit 210.

In more detail, the apparatus for performing authentication can transmit the authentication execution command to the receiving unit 210 if the input device (e.g. a button) included in the apparatus for performing authentication is clicked.

The external device that has transmitted the authentication request signal can comprise an input unit (e.g., a button) for instructing the external device to perform authentication.

Therefore, if the outputting unit 250 outputs the indication representing that it is necessary to perform authentication in response to the indication, the user can click a button of the apparatus for performing authentication or the external device that has transmitted the authentication request signal, to instruct the apparatus for performing authentication and the external device to perform authentication.

In this way, the apparatus for performing authentication of the present exemplary embodiment can very easily perform authentication with the external device by transmitting the authentication request signal just using a button or remote controller without inputting a password or an identification number of the external device with a user's hand.

If the authenticating unit 260 completely performs authentication with the external device, the authentication list registering unit 270 registers the external device that has completely performed authentication with the authentication list that is a list of devices that have performed authentication.

The authentication list registering unit 270 can store at least one of the ID of the external device that has completely performed authentication and the authentication key shared by the apparatus for performing authentication and the external device that has completely performed authentication in order to register the external device that has completely performed authentication with the authentication list.

According to another exemplary embodiment, if no authentication key is required, the authentication list registering unit 270 can store only the ID of the external device that has completely performed authentication.

When the number of external devices registered in the authentication list exceeds the maximum number of authenticated devices, the authentication list registering unit 270 can delete one of the devices registered in the authentication list to register the external device that has performed authentication.

For example, the authentication list registering unit 270 deletes a least frequently used device from the devices registered in the authentication list to register the external device that has performed authentication.

FIG. 4 is a flowchart illustrating a method of performing authentication, according to an exemplary embodiment of the present invention. Referring to FIG. 4, an authentication request signal for requesting authentication is received from an external device (Operation 410).

It is determined whether authentication is performed with the external device that has transmitted the authentication request signal (Operation 420).

If it is determined that authentication is performed with the external device that has transmitted the authentication request signal, it is determined whether the external device has an authentication key (Operation 430).

If it is determined that authentication is not performed with the external device that has transmitted the authentication request signal in Operation 420, or if it is determined that the external device does not have the authentication key in Operation 430, an indication representing that it is necessary to perform authentication with the external device that has transmitted the authentication request signal is output (Operation 440).

An authentication execution command for instructing the execution of authentication in response to the indication representing that it is necessary to perform authentication with the external device that has transmitted the authentication request signal, is received (Operation 450).

Authentication is performed with the external device that has transmitted the authentication request signal according to the authentication execution command (Operation 460).

The above exemplary embodiments of the present invention may be embodied as a computer program. Code and code segments of the computer program may be easily derived by computer programmers skilled in the art to which the present invention pertains. The computer program may be stored in a computer readable medium, and executed using a general digital computer. Examples of the computer-readable medium include a magnetic recording medium (a ROM, a floppy disk, a hard disc, etc.), or an optical recording medium (a CD ROM, a DVD, etc.).

According to an exemplary embodiment of the present invention, an apparatus for performing authentication can receive an authentication request signal for requesting authentication from an external device, determine whether authentication is performed with the external device, based on the determination, selectively output an indication representing that it is necessary to perform authentication with the external device, receive an authentication execution command for instructing the execution of authentication in response to the indication, and perform authentication with the external device according to the authentication execution command, so that a user can easily authenticate devices at home in a wireless environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of performing authentication comprising:
receiving an authentication request signal for requesting authentication from an external device;
determining whether authentication has been performed with the external device that has transmitted the authentication request signal;
based on the determination, selectively outputting an indication representing that it is necessary to perform authentication with the external device;
if the indication representing that it is necessary to perform authentication with the external device is output, receiving an authentication execution command instructing the execution of authentication in response to the indication; and
performing authentication with the external device according to the authentication execution command.

2. The method of claim 1, further comprising: if authentication is completely performed with the external device, registering the external device that has performed authentication with an authentication list that is a list of devices that have performed authentication.

3. The method of claim 2, wherein the registering of the external device comprises: registering at least one of an ID of the external device that has performed authentication and an authentication key shared with the external device that has performed authentication with the authentication list.

4. The method of claim 2, wherein the registering of the external device further comprises: if a number of external devices registered in the authentication list exceeds a maximum number of authenticated devices, deleting one of the devices registered in the authentication list and registering the external device that has performed authentication with the authentication list.

5. The method of claim 4, wherein the registering of the external device further comprises: deleting a least frequently used device from the devices registered in the authentication list and registering the external device that has performed authentication with the authentication list.

6. The method of claim 1, wherein the determining of whether authentication has been performed comprises: determining that authentication has been performed according to whether the external device that has transmitted the authentication request signal is registered with the authentication list that is a list of devices having performed authentication.

7. The method of claim 6, wherein the determining of whether authentication has been performed further comprises: determining that authentication has been performed according to whether at least one of an ID of the external device that has transmitted the authentication request signal and an authentication key shared by the external device that has transmitted the authentication request signal, is stored in the authentication list.

8. The method of claim 1, wherein the selectively outputting of the indication comprises: if it is determined that authentication has not been performed with the external device, outputting the indication representing that it is necessary to perform authentication with the external device.

9. The method of claim 1, further comprising: if it is determined that authentication has been performed with the external device, determining whether the external device has an authentication key,
the indication representing that it is necessary to perform authentication with the external device is selectively output depending on whether the external device has the authentication key.

10. The method of claim 9, wherein the selectively outputting of the indication further comprises: if it is determined that the external device does not have the authentication key, outputting the indication representing that it is necessary to perform authentication with the external device.

11. The method of claim 1, wherein the selectively outputting of the indication further comprises: outputting a predetermined sentence indicating that it is necessary to perform authentication with the external device.

12. The method of claim 1, wherein the selectively outputting of the indication further comprises: outputting a light generated by flickering a screen for a predetermined period of time.

13. The method of claim 1, wherein the receiving of the authentication request signal comprises: further receiving a certificate of the external device that has transmitted the authentication request signal.

14. The method of claim 13, further comprising: determining whether the certificate is valid and whether the certificate is revoked or not,
based on the determination of whether the certificate is valid and whether the certificate is revoked or not, selectively determining whether the external device has performed authentication.

15. The method of claim 14, wherein it is determined whether the external device has performed authentication only if it is determined that the certificate is valid and is not revoked.

16. The method of claim 13, wherein the performing of the authentication comprises:
generating a random number; and
encrypting the random number using a public key of the external device that has transmitted the authentication request signal included in the certificate, and transmitting the encrypted random number to the external device.

17. The method of claim 13, wherein the performing of the authentication further comprises: generating an authentication key according to an authentication key exchange (AKE) of digital transmission content protection (DTCP).

18. The method of claim 1, wherein the receiving of the authentication request signal further comprises: if a plurality of authentication request signals are received, selecting one of a plurality of external devices that have transmitted the plurality of authentication request signals to perform authentication,
determining whether the external device has performed authentication based on the determination of whether the selected external device has performed authentication.

19. An apparatus for performing authentication comprising:
a receiving unit which receives an authentication request signal for requesting authentication from an external device;
an authentication determining unit which determines whether authentication has been performed with the external device that has transmitted the authentication request signal;
an outputting unit which outputs an indication representing that it is necessary to perform authentication with the external device based on the determination made by the authentication determining unit; and
an authenticating unit which, if the receiving unit receives an authentication execution command for instructing the execution of authentication in response to the indication output by the outputting unit, performs authentication with the external device according to the authentication execution command.

20. The apparatus of claim 19, further comprising: an authentication list registering unit which, if the authenticating unit completely performs authentication with the external device, registers the external device that has performed authentication with an authentication list that is a list of devices that have performed authentication.

21. The apparatus of claim 20, wherein the authentication list registering unit stores at least one of an ID of the external device that has performed authentication and an authentication key shared by the external device that has performed authentication in the authentication list.

22. The apparatus of claim 20, wherein the authentication list registering unit, if a number of external devices registered in the authentication list exceeds a maximum number of authenticated devices, deletes one of the devices registered in the authentication list and registers the external device that has performed authentication with the authentication list.

23. The apparatus of claim 22, wherein the authentication list registering unit deletes a least frequently used device from the devices registered in the authentication list and registers the external device that has performed authentication with the authentication list.

24. The apparatus of claim 19, wherein the authentication determining unit determines whether authentication has been performed according to whether the external device that has transmitted the authentication request signal is registered with the authentication list that is a list of devices having performed authentication.

25. The apparatus of claim 24, wherein the authentication determining unit determines whether authentication has been performed according to whether at least one of an ID of the external device that has transmitted the authentication request signal and an authentication key shared by the external device that has transmitted the authentication request signal is stored in the authentication list.

26. The apparatus of claim 19, wherein the outputting unit, if the authentication determining unit determines that authentication has not been performed with the external device, outputs the indication representing that it is necessary to perform authentication with the external device.

27. The apparatus of claim 19, further comprising: an authentication key determining unit which, if the authentication determining unit determines that authentication has been performed with the external device, determines whether the external device has an authentication key,
wherein the outputting unit selectively outputs the indication representing that it is necessary to perform authentication with the external device depending on whether the external device has the authentication key.

28. The apparatus of claim 27, wherein the outputting unit, if the authentication key determining unit determines that the external device does not have the authentication key, outputs the indication representing that it is necessary to perform authentication with the external device.

29. The apparatus of claim 19, wherein the outputting unit outputs a predetermined sentence indicating that it is necessary to perform authentication with the external device.

30. The apparatus of claim 19, wherein the outputting unit outputs a light generated by flickering a screen for a predetermined period of time.

31. The apparatus of claim 19, wherein the receiving unit further receives a certificate of the external device that has transmitted the authentication request signal.

32. The apparatus of claim 31, further comprising: a certificate determining unit which determines whether the certificate is valid and whether the certificate is revoked or not,
the authentication determining unit which, based on the determination made by the certificate determining unit, selectively determines whether authentication has been performed with the external device that has transmitted the authentication request signal.

33. The apparatus of claim 32, wherein the authentication determining unit determines whether authentication has been performed with the external device that has transmitted the authentication request signal only if the certificate determining unit determines that the certificate is valid and is not revoked.

34. The apparatus of claim 31, wherein the authenticating unit comprises:
a random number generating unit which generates a random number;
an encrypting unit which encrypts the random number using a public key of the external device that has transmitted the authentication request signal included in the certificate; and
a transmitting unit which transmits the encrypted random number to the external device that has transmitted the authentication request signal included in the certificate.

35. The apparatus of claim 31, wherein the encrypting unit encrypts an intrinsic identification number of the apparatus for performing authentication using a public key of the external device that has transmitted the authentication request signal included in the certificate, and
wherein the transmitting unit transmits the encrypted intrinsic identification number to the external device that has transmitted the authentication request signal.

36. The apparatus of claim 31, wherein the authenticating unit generates the authentication key according to an authentication key exchange (AKE) of digital transmission content protection (DTCP).

37. The apparatus of claim 19, further comprising: a device selecting unit which, if the receiving unit receives a plurality of authentication request signals, selects one of a plurality of external devices that have transmitted the plurality of authentication request signals to perform authentication,
wherein the authentication determining unit determines whether the external device selected by the device selecting unit has performed authentication.

38. The apparatus of claim 19, further comprising: an input device which transmits the authentication execution command to the receiving unit.

39. The apparatus of claim 38, wherein the input device, if the receiving unit receives the plurality of authentication request signals, transmits a signal for selecting an external device performing authentication from the plurality of external devices that have transmitted the authentication request signals to the receiving unit, and
wherein the authentication determining unit determines whether the external device selected by the signal transmitted from the input device has performed authentication.

40. A computer readable medium having recorded thereon a program for executing the method of claim 1.
